(19) United States
(12) Patent Application Publication
(10) Pub. No.: US 2008/0299933 A1
(43) Pub. Date: Dec. 4, 2008

(54) FLICKER NOISE REDUCTION

(75) Inventors: Yu-Wen (Evan) Chang, Fremont, CA (US); Mohammad R. Moradi, Sunnyvale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MediaPhy Corporation, San Jose, CA (US)

(21) Appl. No.: 12/130,536

(22) Filed: May 30, 2008

Related U.S. Application Data
(60) Provisional application No. 60/941,892, filed on Jun. 4, 2007.

(51) Int. Cl. H04B 1/10

(52) U.S. Cl. 455/307

(57) ABSTRACT

Systems, devices, and methods are described for reducing flicker noise in a wireless multimode receiver. A radio frequency signal may be tuned to a frequency offset from baseband, the tuning generating flicker noise. The tuned signal and flicker noise may be digitized. The digitized signal and flicker noise may be frequency shifted, resulting in the digitized signal being shifted to baseband. The shifted flicker noise may then be filtered, producing a digitized, baseband version of the received signal.

### CROSS REFERENCES

This application claims priority from co-pending U.S. Provisional Patent Application No. 60/941,892, filed Jun. 4, 2007, entitled “FLICKER NOISE REDUCTION” (Attorney Docket No. 025950-000800US), which is hereby incorporated by reference, as if set forth in full in this document, for all purposes.

### BACKGROUND

The present invention relates to wireless communications in general and, in particular, to the reduction of flicker noise.

Flicker noise is a type of noise which occurs in many electronic devices. It results from a variety of effects related to direct current (DC), such as impurities in a conductive channel, generation and recombination noise in a transistor due to base current, and so on. In electronic devices, it is a low-frequency phenomenon, dropping off steadily in higher frequencies.

In communication devices, an intermediate frequency (IF) receiver may be used to mix down a radio frequency (RF) signal to a frequency well above baseband to thereby avoid flicker noise problems. However, such solutions typically consume more power than zero-IF architectures because additional filtering and processing may be required. Thus, it may be desirable to have alternative architectures that address flicker noise reduction while limiting certain drawbacks associated with existing IF solutions.

### SUMMARY

Systems, devices, processors, and methods are described for reducing flicker noise in a receiver. In one set of embodiments, a radio frequency signal is received. The radio frequency signal may be tuned to a frequency offset from baseband, the tuning generating flicker noise. The tuned signal and the generated flicker noise may be frequency shifted, the tuned signal shifted to baseband. The shifted flicker noise may then be filtered, and the baseband signal decimated.

In some embodiments, a device receiving the signal may be a multimode receiver, and the above technique may be used for a number of wideband and narrowband signals. However, for certain standards and bandwidths, the device may be configured to directly convert the received signal to baseband. To identify the proper mode of operation, a determination may be made regarding the standard used to format the signal, and whether the bandwidth of a signal formatted according to certain standards is narrower than a threshold. The tuning and filtering may, therefore, be adapted according to the mode of operation.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a graph illustrating an example of flicker noise.

FIG. 2 is a block diagram of a wireless system configured according to various embodiments of the invention.

FIG. 3 is a block diagram of a device including components configured according to various embodiments of the invention.

FIG. 4 is a block diagram of a framing structure that may be processed according to various embodiments of the invention.

FIGS. 5-8 are graphs illustrating examples of signal filtering and processing according to various embodiments of the invention.

FIG. 9 is a block diagram of a digital filtering unit configured according to various embodiments of the invention.

FIGS. 10-11 are graphs illustrating examples of digital signal filtering and processing according to various embodiments of the invention.

FIGS. 12-13 are graphs illustrating examples of signal filtering and processing according to alternative embodiments of the invention.

FIG. 14 is a flowchart illustrating a method of processing digitized flicker noise according to various embodiments of the invention.

FIG. 15 is a flowchart illustrating a method of flicker noise reduction according to various embodiments of the invention.

FIG. 16 is a flowchart illustrating a method of processing a wireless signal, flicker noise, and a pilot signal according to various embodiments of the invention.

FIGS. 17A and 17B are flowcharts illustrating a method of processing flicker noise according to various embodiments of the invention.

### DETAILED DESCRIPTION OF THE INVENTION

Systems, devices, and methods are described for reducing flicker noise in a wireless receiver. In some embodiments, a radio frequency signal may be tuned to a frequency offset from baseband, the tuning generating flicker noise. The tuned signal and flicker noise may be digitized. The digitized signal and flicker noise may be frequency shifted, resulting in the digitized signal being shifted to baseband. The shifted flicker noise may then be filtered, producing a digitized, baseband version of the received signal.

The following description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components, as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following embodiments may individually or collectively be components of a larger system, wherein other procedures may take precedence over or otherwise modify their application. Also, a number of steps may be required before, after, or concurrently with the following embodiments.

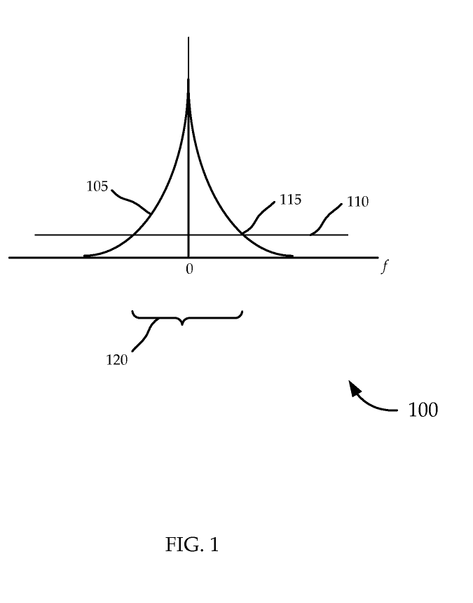

Systems, devices, processors, methods, and software are described for reducing flicker noise (often referred to as 1/f noise). As noted above, flicker noise is inherent in integrated circuits, concentrated in DC, and diminishing as the spectrum spreads out from there. FIG. 1 is a graph 100 illustrating an example of the characteristics of this type of noise 105. Flicker noise 120 may be defined by the intersection of where the noise 105 is equal to the thermal noise floor 110, and the intersection often referred to as the flicker noise corner frequency 115. The flicker noise 120 is typically concentrated around a 100 KHz bandwidth from DC.

In direct conversion receivers, the problem associated with flicker noise 120 may be diminished when there is a relatively wide bandwidth (e.g., 5-8 MHz). With wider bandwidth, there may be a greater number of carriers, which in turn may allow coding gain to offset the effects of the noise. However, for narrowband signals (e.g., ≈400 KHz), direct conversion receivers may not be appropriate, as the proportion of corrupted carriers is increased. This distinction may give rise to unique challenges.

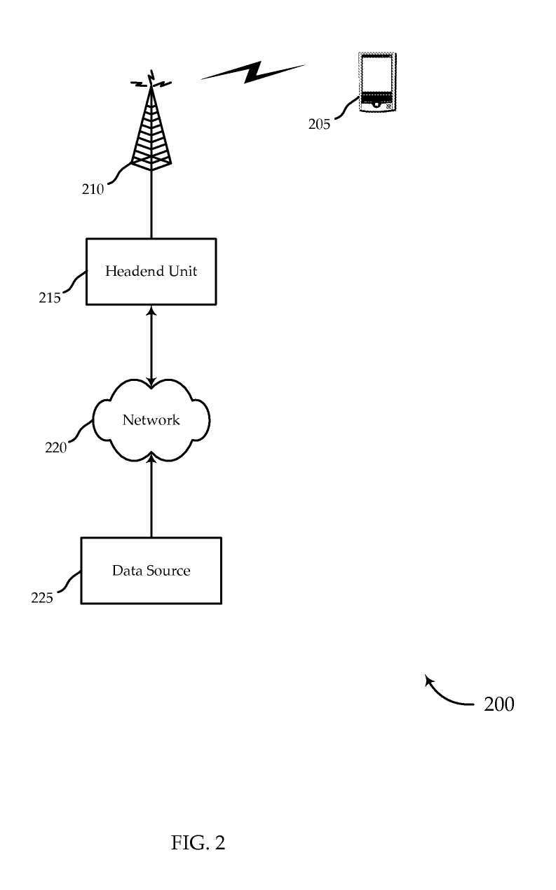

Embodiments are described for reducing flicker noise and problems associated therewith during the reception of wireless signals. Turning to FIG. 2, an example communications system 200 for implementing embodiments of the invention is illustrated. The system includes a communications device 205. The communications device 205 may be a cellular telephone, other mobile phone, personal digital assistant (PDA), portable video player, portable multimedia player, portable DVD player, laptop personal computer, a television in transportation means (including cars, buses, and trains), portable game console, digital still camera or video camcorder, or other device configured to receive wireless communications signals.

In the illustrated embodiment, the device 205 communicates with a headend unit 215 via a radio tower 210. The headend unit 215 and tower 210 may be one of a collection of base stations utilized as part of a system that communicates with the device 205 using wireless signals. The device 205 may receive a wireless signal (e.g., a video broadcast signal) from the headend unit 215. The device may be a multimode receiver, configured to determine the appropriate standard, and whether the signal to be processed is a narrowband or wideband signal. In one set of embodiments, for certain narrowband signals (e.g., ISDB-T), the radio frequency signal may be tuned to a frequency offset from baseband, the tuning generating flicker noise. The tuned signal and the generated flicker noise may be frequency shifted, the tuned signal shifted to baseband. The shifted flicker noise may then be filtered, and the baseband signal decimated. These novel techniques related to the reduction of flicker noise 120 will be described in detail below.

It is worth noting that there may be a variety of different types of infrastructure network devices or sets of devices (not shown) in the system, either in the network 220 or elsewhere. These may include, for example, a Base Station Controller (BSC), or other computer or server, serving as an interface between a network 220 and the headend unit 215.

The network 220 of the illustrated embodiment may be any type of network, and may include, for example, the Internet, an IP network, an intranet, a wide-area network (WAN), a local-area network (LAN), a virtual private network (VPN), the Public Switched Telephone Network (PSTN), or any other type of network supporting data communication between any devices described herein. A network 220 may include both wired and wireless connections, including optical links. The system 200 also includes a data source 225, which may be a server or other computer configured to transmit data (video, audio, or other data) to the communications device 205 via the network 220.

It is worth noting that aspects of the present invention may be applied to a variety of devices (such as communications device 205) generally and, more specifically, may be applied to mobile digital television (MDTV) devices. Aspects of the present invention may be applied to digital video broadcast standards that are either in effect or are at various stages of development. These may include the European standard DVB-H, the Japanese standard integrated service digital broadcasting-terrestrial standard (ISDB-T), the Korean standards digital audio broadcasting (DAB)-based Terrestrial-DMB and Satellite-DMB, the Chinese standards DTV-M, Terrestrial-Mobile Multimedia Broadcasting (T-MMB), Satellite and terrestrial interaction multimedia (STiMi), and the MediaFLO format proposed by Qualcomm Inc. While certain embodiments of the present invention are described in the context of the ISDB-T standard, it may also be implemented in any of the above or future standards, and as such is not limited to any one particular standard.

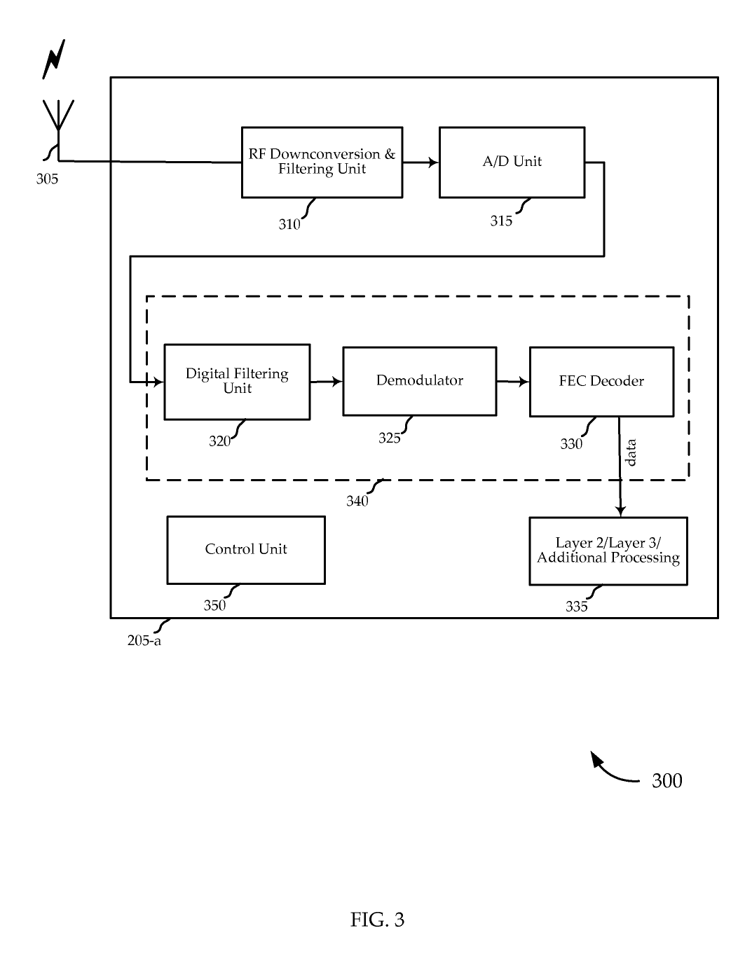

Referring next to FIG. 3, an example block diagram 300 of a device 205-a is shown which illustrates various embodiments of the invention. The device 205-a may be the mobile communications device 205 of FIG. 2. While an assumption will be made that the system at issue processes ISDB-T for narrowband signals, embodiments of the invention may be implemented in a range of other systems. The device 205-a includes a number of receiver components, which may include: an RF down-conversion and filtering unit 310, A/D unit 315, digital filtering unit 320, demodulator unit 325, and FEC decoder unit 330. The device may also include a control unit 350 and a layer 2/layer 3/additional processing unit 335. Any functionality described for the control unit 350 may be performed by the layer 2/layer 3/additional processing unit 335, and vice-versa. The device 205-a may include one or more memory units (not shown) used for a variety of purposes.

In one embodiment, the radio frequency signal is received via an antenna 305. The control unit 350 may determine a standard for the received radio frequency signal (e.g., ISDB-T, DVB-H, DMB). For certain standards (e.g., ISDB-T), the control unit 350 may determine whether the signal of interest should be processed as a narrowband or wideband signal. To do so, the control unit 350 may determine that bandwidth of the signal of interest for the radio frequency signal to be received is narrower (or wider) than a threshold (e.g., the threshold could be 500 KHz, or 2 ISDB-T segments, or 3 ISDB-T segments, etc.). Based on the determination, the RF down-conversion and filtering unit 310, A/D unit 315, digital filtering unit 320, demodulator unit 325, and FEC decoder unit 330 may process the signal according to its bandwidth and formatting characteristics.

Thus, the device 205-a may be a multimode receiver, configured to process wireless signals of different standards, and of varying bandwidths. Depending on the standard and bandwidth, the control unit 350 may identify the radio frequency signal as a signal to be tuned first to a frequency offset from baseband (e.g., a very low IF), the offset identified so that generated flicker noise 120 is outside of the downconverted radio frequency signal of interest. The control unit 350 may, alternatively, identify the radio frequency signal as a signal to be tuned directly to a baseband frequency based at least in part on the identified standard or a determination that the bandwidth is wider than the threshold (e.g., functioning as a direct conversion receiver). Note that novel flicker noise reduction techniques described herein for certain narrowband signals may be implemented in a single mode receiver, and that in one embodiment the device 205-a may be a single mode receiver. Also, note that in some embodiments, wideband and narrowband signals may both be downconverted to the offset. For purposes of discussion, it may be assumed that the device 205-a is a multimode receiver configured to identify an applicable standard and bandwidth for a received transmission, and process the received signal in a manner set forth below.

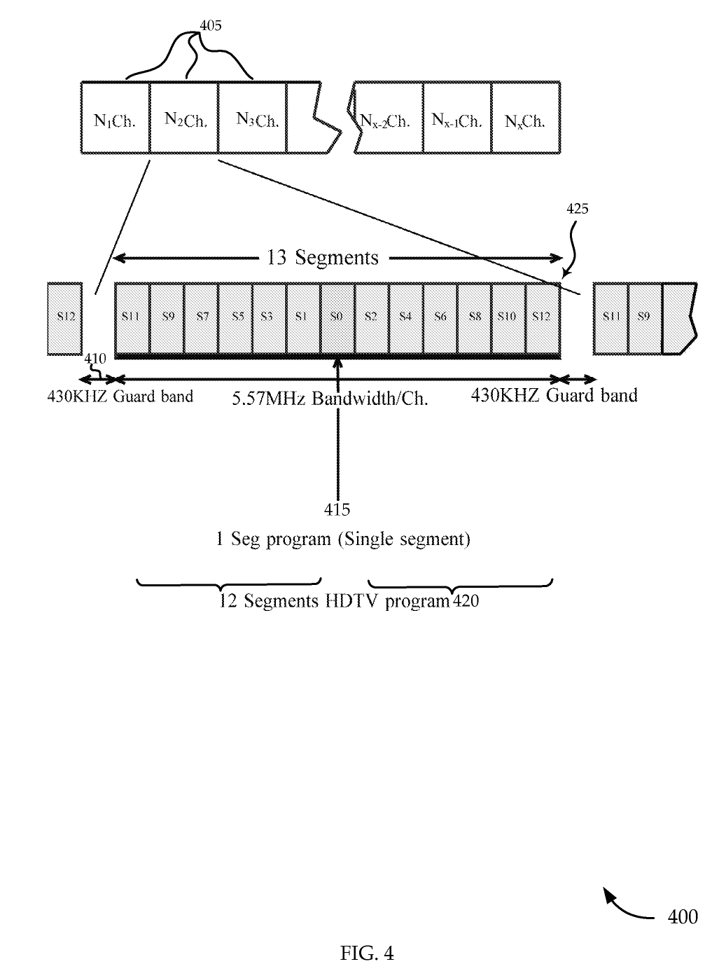

In some standards (e.g., ISDB-T), the same, or similar, content may be transmitted over a narrower band transmission and a wider band transmission. These types of transmissions may be referred to herein as “parallel transmissions.” The device 205-a may be configured to process such bands differently. FIG. 4 illustrates an example of such a parallel transmission 400, showing an example of an ISDB-T implementation. In the illustrated example, each of a series of channels 405 occupies consecutive 5.572 MHz bands of spectrum, separated by guard bands 410. Within each channel, the narrowband transmission may be a single 428 KHz segment 415, or 1-seg transmission. This 1-seg transmission may carry the same content (albeit with lower definition) as the collective 12 segments 420 which surround it. In other embodiments, other distributions of segments are possible (e.g., 3 segments for a narrower band and 10 segments for a wider band in one embodiment, or 1 segment for a narrower band, 4 segments for a mid-sized band, 8 segments for a wider band). As noted above, this is but one example of parallel transmissions, and in other embodiments other standards may be used (e.g., advanced television standards committee (ATSC) digital television (wideband) and mobile (narrowband).

The device 205-a of FIG. 3 may, therefore, be configured to receive and process narrowband and wideband ISDB-T signals differently. Narrowband ISDB-T signals may be tuned to a frequency offset from baseband (e.g., a very low IF), the offset identified so that generated flicker noise 120 is substantially outside of the radio frequency signal. Wideband ISDB-T signals may be tuned directly to a baseband frequency (e.g., the device 205-a functioning as a direct conversion receiver). In other embodiments, wideband ISDB-T signals may be tuned to the same offset as the narrowband, or tuned to a low IF that is a higher frequency than the flicker noise. In other embodiments, a range of IF architectures may be used to process wideband signals

Turning back to FIG. 3, the received signal is selected, downconverted, and filtered through the RF down-conversion and filtering unit 3 10. Assume a determination about a standard is made. As noted, in some embodiments the RF down-conversion and filtering unit 310 may process wideband signals (e.g., DVB-H, DMB, ISDB-T wideband) differently than certain narrowband signals (e.g., ISDB-T). The RF down-conversion and filtering unit 310 may be a part of an analog receiver unit for the device 205-a. To illustrate this functionality, the discussion will be centered on the processing of certain narrowband signals, while recognizing the adaptability of the device 205-a in some embodiments.

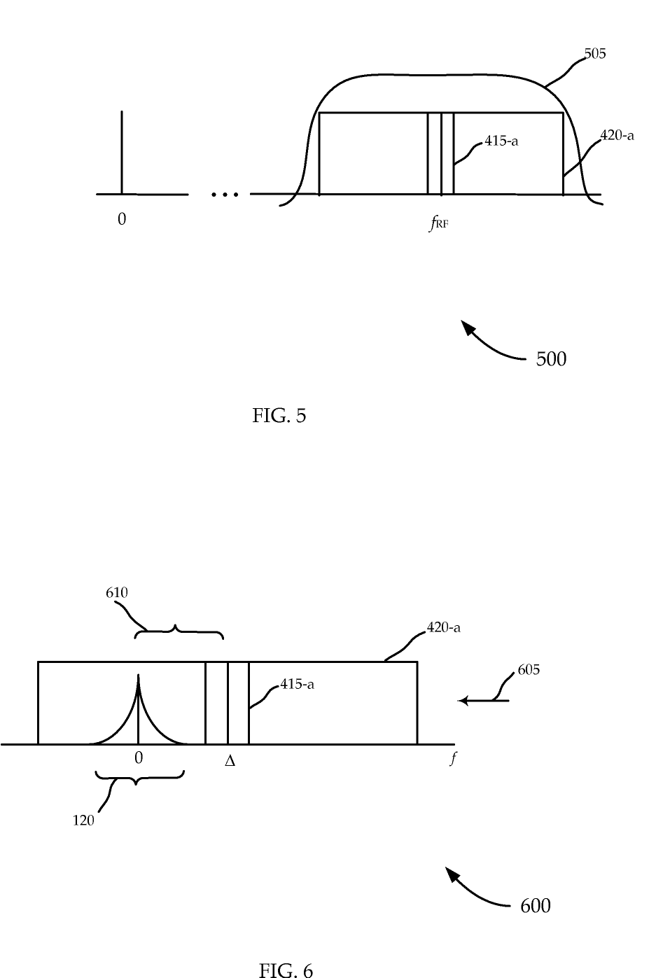

Examples of the functionality of the RF down-conversion and filtering unit 310 will be illustrated with the graphs of FIGS. 5-8. FIG. 5 is a graph 500 illustrating a received signal, and how in one embodiment the device may receive both wideband signals (e.g., DVB-H, DMB, ISDB-T wideband) and narrowband signals (e.g., ISDB-T narrowband). In the illustrated embodiment, assume that an ISDB-T signal is received, including a narrowband 415 and wideband 420 component. The device 205-a may make a determination of the standard (ISDB-T) and bandwidth (narrowband) of the signal of interest to be received. The device 205-a may filter 505 the signal according to this determination, filtering as appropriate for the desired frequency and bandwidth. FIG. 5 thus illustrates how the radio frequency signal may be selected.

FIG. 6 is a graph 600 illustrating an example analog downconversion 605 of an RF signal to an offset 610, as performed by the RF down-conversion and filtering unit 310. The process of downconversion may introduce the flicker noise 120. In one embodiment, the RF signal is tuned by an amount equal to the frequency of the RF signal plus or minus a Δ (e.g., the RF signal may be tuned by f_{RF}±Δ to reach the offset). The Δ frequency in one embodiment is equal to the sampling frequency divided by 4 (f_{S}/4). In other embodiments, there are a number of options regarding how to determine the Δ frequency. For example, it may be set in the same manner, or differently, depending on the standard in use, and the bandwidth of the signal of interest. In one embodiment, the offset 610 is configurable to be a specified distance from an estimated flicker noise corner frequency 115. This configurable offset 610 may, therefore, be set based on the bandwidth of the signal of interest and the estimated flicker noise corner frequency 115. As noted above, in some embodiments the RF down-conversion and filtering unit 310 may downconvert to the offset 610 for only some narrowband signals, and may perform direct conversion for wideband signal or signals with bandwidth over a threshold (e.g., directly converting DMB, DVB-H, and certain ISDB-T wideband signals). In other embodiments, all received signals will first be downconverted to an offset 610. Also, the RF down-conversion and filtering unit 310 may be configured to dynamically adjust the Δ frequency based on current performance metrics (e.g., a decreasing a signal to noise ratio measurement received from the control unit 350 may trigger a larger Δ frequency to avoid the flicker noise).

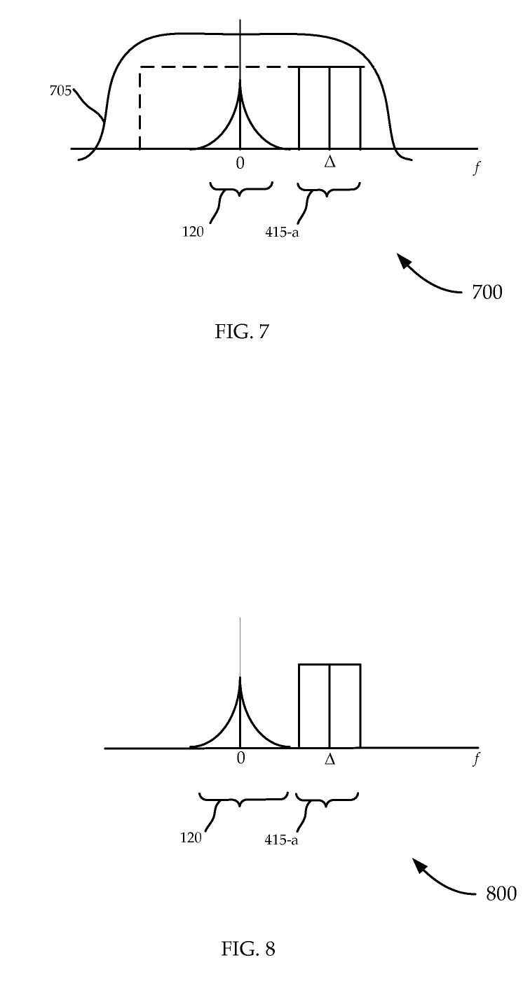

Turning to the graph 700 of FIG. 7, and assuming the narrowband ISDB-T signal 415-a is the signal of interest, the RF signal may be filtered 705 in a manner targeted to the narrowband signal 415-a of interest. This filtering is, in one embodiment, based on knowledge of the bandwidth and location of the signal of interest (e.g., knowledge of the location of a 1-seg ISDB-T signal of interest). This filtering 705 may be performed by the RF down-conversion and filtering unit 310 of FIG. 3 in the analog domain. However, other analog or digital filtering variations are possible, as well. For wideband signals, this filtering would be avoided (or widened) to allow the wider signal of interest to pass.

Thus, the graph 800 of FIG. 8 illustrates an example of the narrowband ISDB-T signal 415-a and flicker noise 120, which may be output from the RF down-conversion and filtering unit 310 of FIG. 3. Referring back to FIG. 3, this output of the RF down-conversion and filtering unit 310 may be converted into a digital signal by the A/D unit 315. This digitized signal (including the narrowband signal 415-a and flicker noise 120 shown in FIG. 8) may be forwarded at the sampling rate (f_{S}) to the digital filtering unit 320. For a wideband signal (e.g., DVB-H, DMB, ISDB-T wideband), the wider bandwidth may be digitized by the A/D unit 315 and forwarded. Thus, in one embodiment, a same wideband tuner (such as a tuner in the RF down-conversion and filtering unit 310) may be used to receive both narrowband and wideband signals, and the narrowband analog signals may be filtered more tightly to receive the particular narrowband signal of interest. Also, the bandwidth to be digitized by the A/D unit 315, and the sampling rate, may be configurable. However, in other embodiments, it is worth noting that the signal processing described herein may also be performed for only narrowband (or for only wideband) signals. Also, a variety of filtering techniques may be used or foregone depending on the particular implementation.

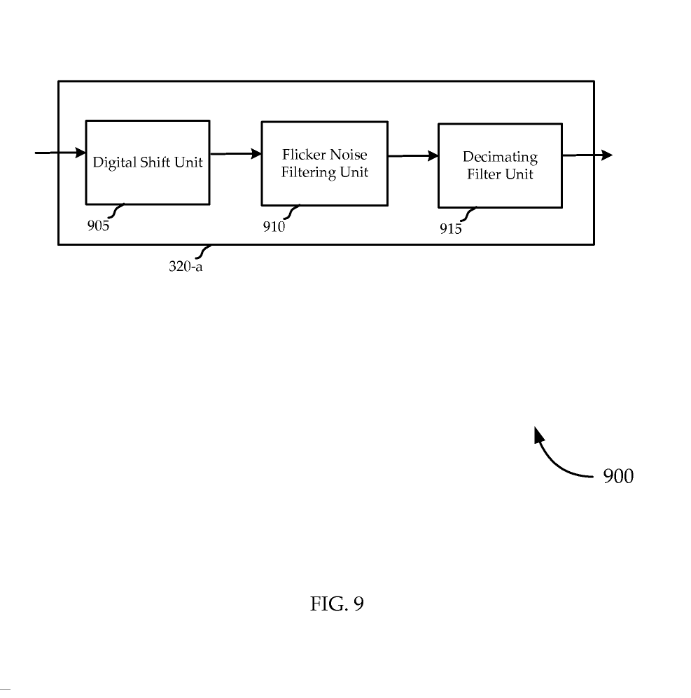

Regardless, the digital filtering unit 320 may receive the digitized signal at the sampling frequency (f_{S}). The digital filtering unit 320 may be configured to receive and frequency shift the digitized signal 415-a and the digitized flicker noise 120, the digitized signal 415-a shifted to baseband. The digital filtering unit 320 may filter out the shifted flicker noise 120, and decimate the digitized, baseband signal. FIG. 9 is a block diagram 900 illustrating an example configuration for a digital filtering unit 320-a according to certain embodiments of the invention. The digital filtering unit 320-a may be the digital filtering unit 320 of FIG. 3. The digital filtering unit 320-a may include a digital shift unit 905, a flicker noise filtering unit 910, and a decimating filter unit 915.

A digitized signal (e.g., made up of signal 415-a and the flicker noise 120 of FIG. 8) may be received by the digital shift unit 905, and may be shifted by the offset frequency so that the signal 415-a is shifted to baseband. Note that if a device is functioning in a direct conversion mode (e.g., processing a DMB, DVB-H, or ISDB-T wideband signal), the digital shift unit 905 (or some or all of the rest of the components of the digital filtering unit 320-a) may be suspended or bypassed. The shift may be in the same frequency direction as the analog tuning, or may be in the opposite direction (e.g., if the tuning is f_{RF}+{). The shifted digitized signal components may be output at the sampling rate f_{S}) from the digital shift unit 905 to a flicker noise filtering unit 910. In one embodiment, the flicker noise 120 component has been shifted to be centered at approximately the −Δ frequency, and the flicker noise filtering unit 910 may be configured to filter this flicker noise. The digitized signal 415-a may be output from the flicker noise filtering unit 910 and may be output at the sampling rate (f_{S}) to the decimating filter unit 915. The decimating filter unit 915 may then decimate the signal, and may output the decimated signal at f_{S}/Q (e.g., where Q=4 or 8). Other decimating calculations (e.g., to cut down speed or power, or increase performance) may be used in other embodiments. The output of the decimating filter unit 915, at the reduced sampling rate, is then forwarded.

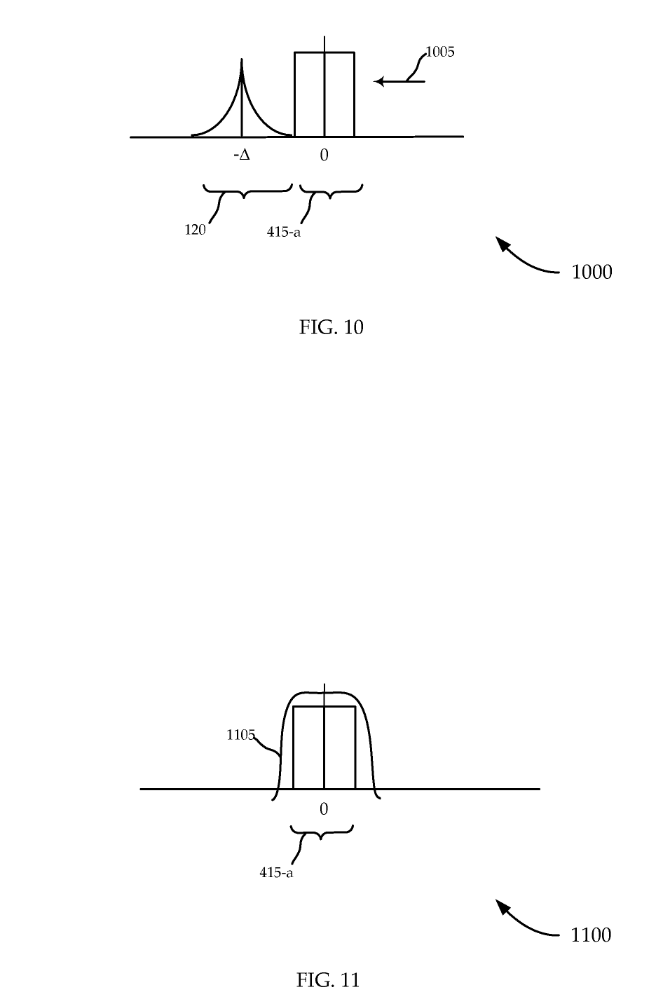

In order to illustrate this functionality, consider first an example of the processing of the digitized flicker noise 120 and digitized narrowband ISDB-T signal 415-a illustrated in FIG. 8, forwarded to the digital filtering unit 320 of FIG. 3 or 9. FIG. 10 is a graph 1000 illustrating the shift 1005 that may be performed by a digital shift unit 905 on the flicker noise 120 and narrowband signal 415-a components. With the shift 1005, the narrowband signal 415-a of interest is shifted to baseband, centered substantially at 0 Hz, while the flicker noise 120 has been shifted to be centered at the −Δ frequency. While in this embodiment, the narrowband ISDB-T signal 415-a is shown, a similar frequency shift may occur for other narrowband or wideband signals.

The shifted digitized signal from FIG. 10 may be output at the sampling rate (f_{S}) from the digital shift unit 905 to a flicker noise filtering unit 910. FIG. 11 is a graph 1100 illustrating the filtering 1105 of the flicker noise 120 and other signals outside of the narrowband signal 415-a of interest. It is worth noting that for wideband signals, the filtering functions of the flicker noise filtering unit 910 may be bypassed or the filter bandwidth widened. As noted above, a relatively wide bandwidth (e.g., 5-8 MHz) means that there may be a greater number of carriers, which in turn may allow coding gain. The flicker noise 120 might be within carriers of interest for the wideband signal, and thus the filtering could remove desired carrier data. A control unit 350 of FIG. 3 may be configured to control the filtering, and perhaps modify the filtering width, so that the flicker noise filtering is avoided or reduced when the flicker noise is within the signal of interest.

Returning to FIG. 3, at the demodulator unit 325, the filtered and digitized signal from digital filtering unit 320 (of FIG. 3 or 9) is received and processed to produce a stream of data. The demodulator unit 325 may perform symbol synchronization, FFT processing, frequency offset correction and estimation, and equalizer functions in a variety of combinations known in the art, based on the standard used, and the bandwidth and carrier issues.

The data from the demodulator unit 325 may be forwarded to a FEC decoder unit 330, which may decode the signal and output a stream of data (note that the data may be further processed by other components of the demodulator unit 325 before being forwarded to FEC decoder unit 330, and in some embodiments the transmitted data need not be encoded so there need not be a FEC decoder unit 330). This data stream may be forwarded to a layer 2/layer 3/additional processing unit 335 for further processing. It is worth noting that, in one embodiment, the digital filtering unit 320, demodulator unit 325, and FEC decoder unit 330 are receiver components 340 implemented in a single PHY chip. It is also worth noting that in another embodiment, the RF down-conversion and filtering unit 310, A/D unit 315, digital filtering unit 320, demodulator unit 325, and FEC decoder unit 330 are receiver components implemented in a single chip with RF and PHY functionality.

With a description of the processing path through the device 205-a of FIG. 3 complete, an alternative embodiment will now be described. Again consider the ISDB-T signal structure 400 set forth in FIG. 4. In some transmissions, there is a pilot signal (e.g., a continuous pilot) that may be added at the edge of an upper side segment 425 (shown in FIG. 4). Further, consider an instance in which a narrowband ISDB-T signal 415 is the signal of interest, and this pilot signal is to be used by a receiver (e.g., device 205 of FIG. 2 or 3) for purposes of channel estimation.

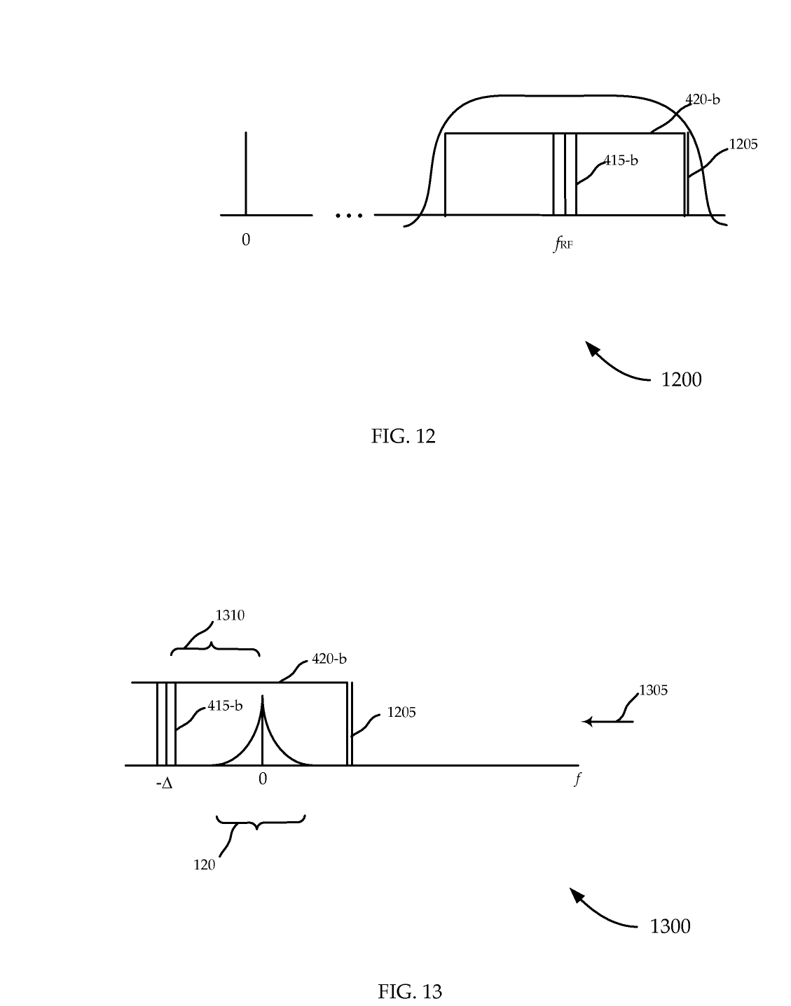

FIG. 12 is a graph 1200 illustrating a received signal, and how in one embodiment the device 205 of FIG. 2 or 3 may process both a pilot signal 1205 and a narrowband ISDB-T signal 415-b. In the illustrated embodiment, assume that an ISDB-T signal is received, including a narrowband 415-b and wideband component 420-b. The device 205-a may make a determination of the standard (ISDB-T) and bandwidth (narrowband) of the signal to be received.

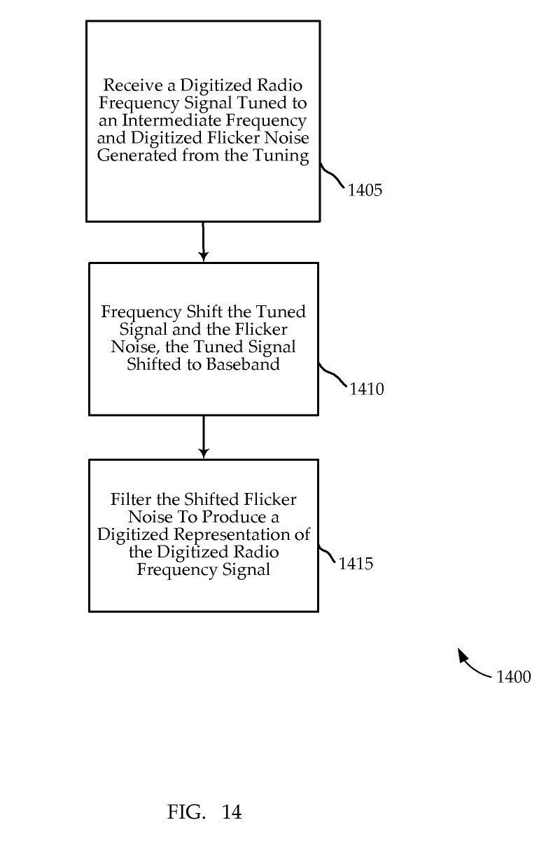

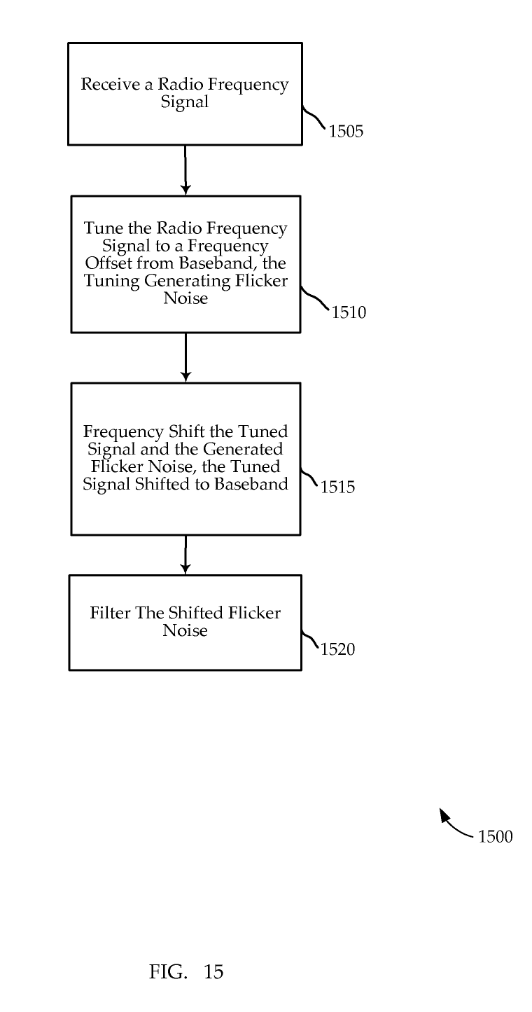

FIG. 13 is a graph 1300 illustrating an example of analog downconversion 1305 of an ISDB-T 420-b to an offset 1310. The process of tuning may introduce the flicker noise 120. In one embodiment, the ISDB-T signal 415-b, 420-b is downconverted by an amount equal to the center frequency plus a Δ (e.g., the signal is tuned by f_{RF}+Δ to reach the offset). Thus, the narrowband ISDB-T signal 415-b is tuned to a frequency offset 1310 from baseband, the tuning introducing flicker noise 120 located at a frequency between the tuned narrowband ISDB-T signal 415-b and the tuned pilot signal 1205. The tuned narrowband ISDB-T signal 415-b, flicker noise 120, and pilot 1205 may then be digitized and frequency shifted (not shown) in an amount approximating the offset, and in a direction opposite of the tuning. The shifted flicker noise may be filtered, and the narrowband ISDB-T signal 415-b may be recovered while the pilot signal 1205 is used for channel estimation.

Although the functionality set forth is this disclosure may be described with reference to the device 205 of FIG. 2 or 3 and its components, the functionality may be performed by a variety of other components in this or other types of devices. The functional units (e.g., RF down-conversion and filtering unit 310, A/D unit 315, digital filtering unit 320, demodulator unit 325, or FEC decoder unit 330 of FIG. 3, or the digital shift unit 905, flicker noise filtering unit 910, or decimating filter unit 915 of FIG. 9) may, individually or collectively, be implemented with one or more Application-Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. It should also be noted that, although certain concepts related to sampling rate are set forth, a range of sampling techniques may be employed. Also, while examples of analog and digital filtering are used, certain functionality may be performed in the analog or digital domain.

FIG. 14 is a is a flowchart illustrating a method 1400 of processing digitized flicker noise according to various embodiments of the invention. The method 1400 may, for example, be performed in whole or in part on the mobile communications device 205 of FIG. 2 or 3 or, more specifically, using the digital filtering unit 320 of FIG. 3 or 9.

At block 1405, a digitized radio frequency signal tuned to an intermediate frequency and digitized flicker noise generated from the tuning is received. At block 1410, the tuned signal and the flicker noise are frequency shifted, the tuned signal shifted to baseband. At block 1415, the shifted flicker noise is filtered to produce a digitized representation of the digitized radio frequency signal.

FIG. 15 is a flowchart illustrating a method 1500 of flicker noise reduction according to various embodiments of the invention. The method 1500 may, for example, be performed in whole or in part on the mobile communications device 205 of FIG. 2 or 3.

At block 1505, a radio frequency signal is received. At block 1510, the radio frequency signal is tuned to a frequency offset from baseband, the tuning generating flicker noise. At block 1515, the tuned signal and the generated flicker noise are frequency shifted, the tuned signal shifted to baseband. At block 1520, the shifted flicker noise is filtered.

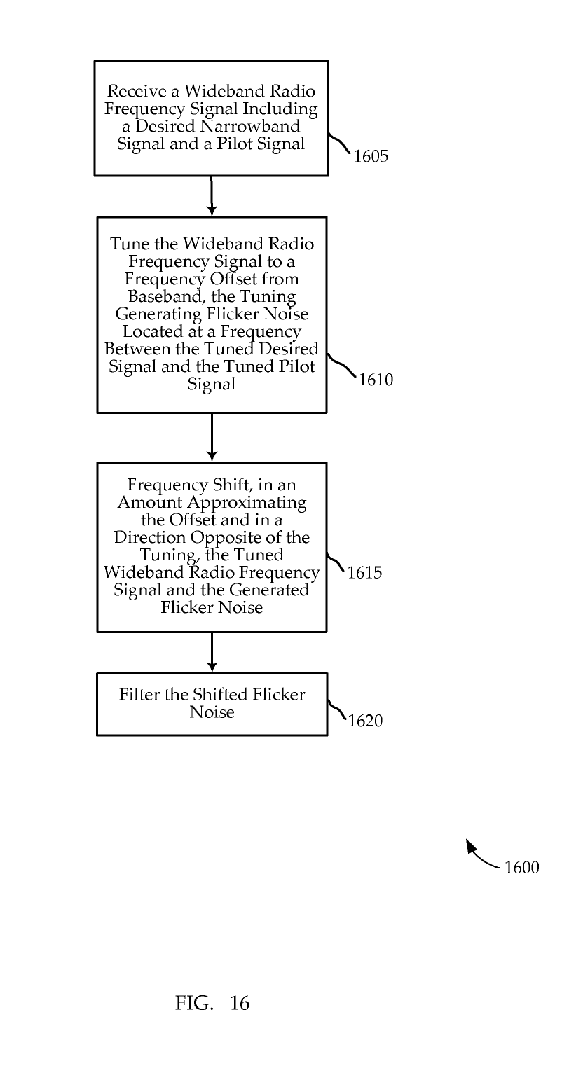

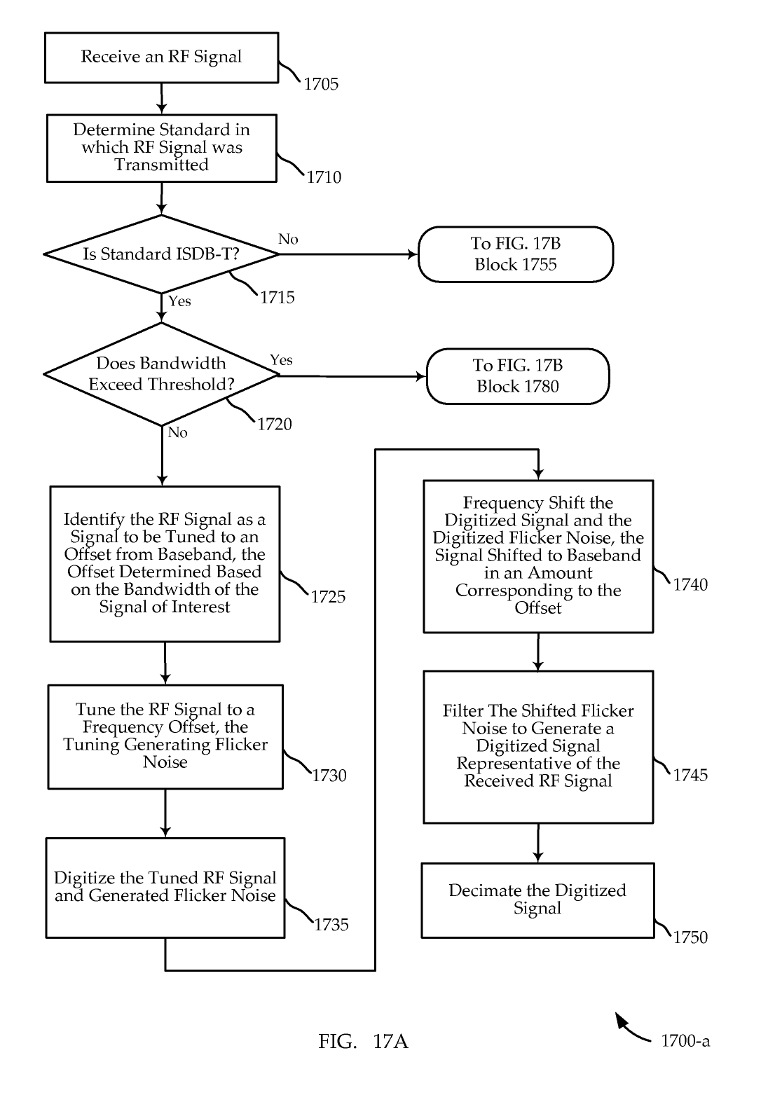

FIG. 16 is a flowchart illustrating a method 1600 of flicker noise reduction according to various embodiments of the invention. The method 1600 may, for example, be performed in whole or in part on the mobile communications device 205 of FIG. 2 or 3.

At block 1605, a wideband radio frequency signal, including a desired narrowband signal and a pilot signal, is received. At block 1610, the wideband radio frequency signal is tuned to a frequency offset from baseband, the tuning generating flicker noise located at a frequency between the tuned desired signal and the tuned pilot signal. At block 1615, the tuned wideband radio frequency signal and the generated flicker noise are frequency shifted in an amount approximating the offset. At block 1620, the shifted flicker noise is filtered.

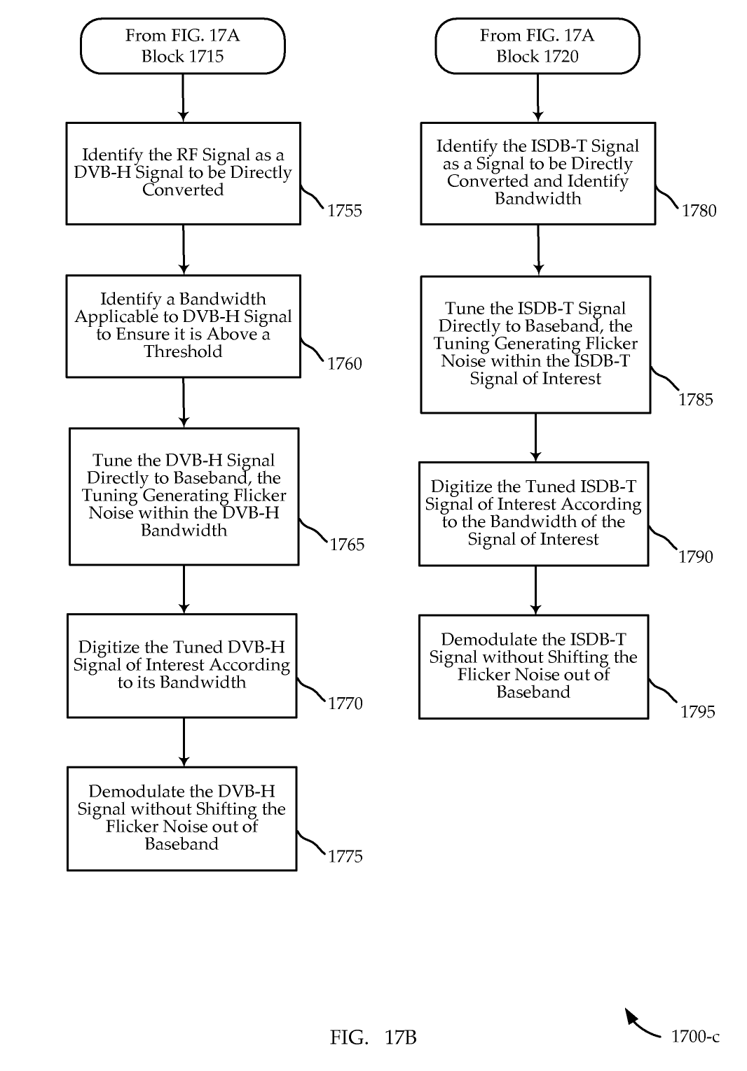

FIGS. 17A and 17B are flowcharts illustrating a method 1700 of reducing flicker noise according to various embodiments of the invention. The method 1700 may, for example, be performed in whole or in part on the mobile communications device 205 of FIG. 2 or 3.

At block 1705, a radio frequency signal is received. At block 1710, the standard in which the RF signal was transmitted is determined. At block 1715, a determination is made whether the standard is ISDB-T. If it is determined that the standard is ISDB-T, then at block 1720 a determination is made whether the bandwidth for the signal of interest exceeds a threshold (e.g., is 2 segs or greater). If it is determined that the bandwidth does not exceed threshold (e.g., is a 1-seg narrowband transmission), then at block 1725 the RF signal is identified as a signal to be tuned to an offset, the offset determined based on the bandwidth of the signal of interest. At block 1730, the RF signal is tuned to a frequency offset from baseband, the tuning generating flicker noise. At block 1735, the tuned signal and generated flicker noise are digitized. At block 1740, the digitized signal and the digitized flicker noise are shifted, the digitized signal shifted to baseband in an amount corresponding to the offset. At block 1745, the shifted flicker noise is filtered, thereby generating a digitized signal representative of the received radio frequency signal. At block 1750, the digitized signal is decimated.

If, at block 1715, it is determined that ISDB-T is not the standard, then at block 1755 the RF signal is identified as a DVB-H signal to be directly converted. At block 1760, a bandwidth applicable to a DVB-H signal is identified to ensure it is above a threshold. At block 1765, the DVB-H signal is tuned directly to baseband, the tuning generating flicker noise within the DVB-H signal of interest. At block 1770, the tuned DVB-H signal of interest is digitized according to its bandwidth. At block 1775, the DVB-H signal is demodulated without shifting the flicker noise out of baseband. This may be accomplished because the coding gain may correct data which would otherwise be corrupted due to the flicker noise.

If at block 1720, it is determined that bandwidth for the ISDB-T exceeds a threshold (e.g., is wider than 1-seg), then at block 1780 the ISDB-T signal may be identified as a signal to be directly converted, and the bandwidth for the signal of interest may be identified. At block 1785, the ISDB-T signal is tuned directly to baseband, the tuning generating flicker noise within the ISDB-T signal of interest. At block 1790, the tuned ISDB-T signal of interest is digitized according to the bandwidth of the signal of interest. At block 1795, the ISDB-T signal is demodulated without shifting the flicker noise out of baseband. It is worth noting that in other embodiments, some or all wideband signals may be tuned to the offset, as well.

It should be noted that the systems, devices, and methods discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A mobile communications device configured to process a received radio frequency signal, the device comprising:
an analog receiver unit configured to:
receive a radio frequency signal; and
tune the radio frequency signal to a frequency offset from baseband, the tuning generating flicker noise;
a digital shift unit, communicatively coupled with the analog receiver unit, and configured to frequency shift the tuned signal and the generated flicker noise, the tuned signal shifted to baseband; and
a flicker noise filtering unit, communicatively coupled with the analog receiver unit, and configured to filter the flicker noise.

2. The device of claim 1, further comprising:
a decimating filter unit, communicatively coupled with the digital filter unit, and configured to decimate the baseband signal.

3. The device of claim 1, further comprising:
an analog to digital converter unit, communicatively coupled with the analog receiver unit and digital tuning unit, and configured to digitize the tuned signal and the generated flicker noise, wherein the digital tuning unit is configured to perform the frequency shift on the digitized tuned signal and the digitized flicker noise.

4. The device of claim 1, further comprising:
an analog to digital converter unit, communicatively coupled with the analog receiver unit, and configured to digitize the tuned signal and the generated flicker noise, wherein a width of frequency to be digitized is configurable based on bandwidth of an identified signal of interest.

5. The device of claim 1, wherein the analog receiver unit is further configured to tune the radio frequency signal by an amount comprising the radio frequency signal plus the offset or the amount comprising the radio frequency signal minus the offset.

6. The device of claim 1, wherein the frequency shift direction is in the opposite direction of the tuning.

7. The device of claim 1, further comprising:
a control unit configured to:
determine a standard for the radio frequency signal to be received, the standard determined from a plurality of standards; and
identify the offset amount for the tuning based at least in part upon the determined standard.

8. The device of claim 1, further comprising:
a control unit configured to:
determine that a bandwidth of the radio frequency signal to be received is narrower than a threshold;
identify the radio frequency signal as a signal to be tuned to the offset based at least in part on the determination, the offset identified so that the generated flicker noise is substantially outside of the radio frequency signal narrower than the threshold; and
identify, for the digital tuning unit, an amount of the shift of the radio frequency signal to correspond to the offset.

9. The device of claim 8, wherein,
the control unit is further configured to:
determining that a bandwidth of a second radio frequency signal to be received is wider than the threshold;
identify the second radio frequency signal as a signal to be tuned directly to the baseband frequency based at least in part on the determination that the bandwidth of the second radio frequency signal to be received is wider than the threshold; and
control the digital tuning unit to prevent the digital tuning unit from shifting the second radio frequency signal.

10. The device of claim 1, further comprising:
a control unit configured to:
determine that a narrowband portion of the radio frequency signal is to be processed; and
identify the radio frequency signal as a signal to be tuned to the offset based at least in part on the determination, wherein the control unit is configured to control the analog receiver unit to tune the radio frequency signal directly to baseband when it is determined that a wideband portion of the radio frequency signal is to be processed.

11. The device of claim 1, wherein,
the analog receiver unit is further configured to tune a second received radio frequency signal so that flicker noise is generated within the tuned second received radio frequency signal.

12. A method of processing a radio frequency signal, the method comprising:
receiving a radio frequency signal;
tuning the radio frequency signal to a frequency offset from baseband, the tuning generating flicker noise;
frequency shifting the tuned signal and the generated flicker noise, the tuned signal shifted to baseband; and
filtering the shifted flicker noise.

13. The method of claim 12, further comprising:
decimating the baseband signal.

14. The method of claim 12, further comprising:
digitizing the tuned signal and the generated flicker noise, wherein the frequency shift is performed on the digitized tuned signal and the digitized flicker noise.

15. The method of claim 12, wherein the frequency shift is in the opposite direction of the tuning.

16. The method of claim 12, further comprising:
determining a standard for the radio frequency signal to be received, the standard determined from a plurality of standards,
wherein the tuning amount is based upon the determined standard.

17. The method of claim 12, further comprising:
determining that a bandwidth of the radio frequency signal to be received is narrower than a threshold,
wherein the radio frequency signal is tuned to the frequency offset from baseband is based at least in part on the determination.

18. The method of claim 17, further comprising:
determining that a bandwidth of a second radio frequency signal to be received is wider than the threshold,
wherein the second radio frequency signal is directly tuned to the baseband frequency based at least in part on the determination that the bandwidth of the second radio frequency signal to be received is wider than the threshold.

19. The method of claim 18, wherein,
the radio frequency signal narrower than the threshold is an integrated services digital broadcasting terrestrial narrowband signal; and
the second radio frequency signal to be received is an integrated services digital broadcasting terrestrial wideband signal.

20. A processor for processing a digitized representation of a wireless signal, the processor configured to:
receive a digitized radio frequency signal tuned to a frequency offset from baseband and digitized flicker noise generated by the tuning;
frequency shift the tuned signal and associated flicker noise, the tuned signal shifted to baseband; and
filter the flicker noise to produce a digitized representation of the digitized radio frequency signal.

21. The processor of claim 20, further configured to:
tune an analog version of the radio frequency signal to the frequency offset from baseband, the tuning generating flicker noise; and
digitize the tuned frequency signal and the flicker noise to generate the received digitized radio frequency signal and the received digitized flicker noise.

22. A method of processing a radio frequency signal, the method comprising:
digitizing a radio frequency signal tuned to a frequency offset from baseband and flicker noise generated from the tuning;
frequency shifting the digitized tuned signal and the digitized flicker noise, the tuned signal shifted to baseband; and
filtering the flicker noise to produce a digitized representation of the digitized radio frequency signal.

23. The method of claim 22, further comprising:
receiving the radio frequency signal; and
tuning the radio frequency signal to the frequency offset from baseband, the tuning causing flicker noise to be generated.

24. A method of processing a radio frequency signal, the method comprising:
receiving a wideband radio frequency signal including a desired narrowband signal and a pilot signal;
tuning the wideband radio frequency signal to a frequency offset from baseband, the tuning generating flicker noise located at a frequency between the tuned desired signal and the tuned pilot signal;
frequency shifting, in an amount comprising the offset, the tuned wideband radio frequency signal and the generated flicker noise; and
filtering the shifted flicker noise to produce the desired narrowband signal and the pilot signal.

25. The method of claim 24, further comprising:
estimating channel using the pilot signal.
